(19) United States
(12) Patent Application Publication
(10) Pub. No.: US 2012/0272480 A1
(43) Pub. Date: Nov. 1, 2012

(54) MAGNETORHEOLOGICAL FLUID FILLED HINGES FOR MOTION CONTROL

(75) Inventor: Shivaram Ac, Bangalore (IN)

(73) Assignee: GM GLOBAL TECHNOLOGY OPERATIONS LLC, Detroit, MI (US)

(21) Appl. No.: 13/094,874

(22) Filed: Apr. 27, 2011

(51) Int. Cl. E05D 11/10; H01F 7/06; H01F 7/02

(52) U.S. Cl. 16/320

(57) ABSTRACT

A hinge is provided for pivotably mounting a first attachment member to a second attachment member. A first member is attached to the first attachment member. A second member pivotably engages the first member and is disposed within the first member. The second member is configured for attachment to the second attachment member. An annular cavity is disposed between the first member and the second member. The annular cavity maintains a spaced relationship between the first member and the second member. A magnetorheological fluid is disposed within the annular cavity. A magnetic field generating member is configured to produce a change in a shear strength of the magnetorheological fluid within the annular cavity. The magnetorheological fluid applies a variable resistance torque between the first member and the second member for controlling a pivoting motion between the first member and the second member.

### BACKGROUND OF INVENTION

An embodiment relates generally to hinge devices.

Various moving components utilize a hinge to pivot from one position to another position. A hinge is typically a type of bearing that is secured to two moving objects and allows a respective angle of rotation between them. The two objects that are connected by the hinge rotate relative to each other about a respective fixed axis of rotation.

The ability the hinge to freely rotate depends on, among other factors, the resistance built into the bearing surface of the hinge when it is manufactured. Typically, a resistance member is added to the hinge assembly that applies a resistance force to slow down or soften the opening of the two members. For example a vehicle door may have spring-like member that provides a resistance for slowing pivoting of the two components. This is typically preferred when it is undesirable to have a member pivot fast to its open or closed position where the speed of the moving member when it reaches the end of travel may generate a counter force in moving the opening part back towards its original position. The resistance member is typically a mechanical part that requires additional cost and packaging space.

### SUMMARY OF INVENTION

An advantage of an embodiment is controlling the movement of a hinge assembly by controlling magnetorheological (MR) fluid within an annular cavity formed between a fixed member and a pivoting member of a hinge assembly via a magnetic field exerted on the MR fluid. The magnetic field may be generated by permanent magnets, electromagnets, or a combination of both permanent magnets and electromagnets formed within the hinge assembly. The magnetic field may be variably controlled to control the speed that the hinge is able to rotate and may control the distance that the hinge assembly is pivotably displaced. This is accomplished within a relatively small package space, and allows for variable control of the hinge.

An embodiment contemplates a hinge for pivotably mounting a first attachment member to a second attachment member. A first member is attached to the first attachment member. A second member pivotably engages the first member and is disposed within the first member. The second member is configured for attachment to the second attachment member. An annular cavity is disposed between the first member and the second member. The annular cavity maintains a spaced relationship between the first member and the second member. A magnetorheological fluid is disposed within the annular cavity. A magnetic field generating member is configured to produce a change in a shear strength of the magnetorheological fluid within the annular cavity. The magnetorheological fluid applies a variable resistance torque between the first member and the second member for controlling a pivoting motion between the first member and the second member.

### BRIEF DESCRIPTION OF DRAWINGS

FIG. 1 is a perspective view of a working hinge.

FIG. 2 is a schematic, partial cut away section of the hinge assembly according to a first preferred embodiment.

FIG. 3 illustrates the magnetic field generated by the magnetic field generating member according to the hinge assembly shown in FIG. 2.

FIG. 4 is a schematic, partial cut away section of the hinge assembly according to a second preferred embodiment.

FIG. 5 illustrates the magnetic field generated by the magnetic field generating members according to the hinge assembly shown in FIG. 4.

FIG. 6 is a schematic, partial cut away section of the hinge assembly according to a third preferred embodiment.

FIGS. 7a-7c illustrate various magnetic field generated by the magnetic field generating members according to the hinge assembly shown in FIG. 6.

FIG. 8 is a schematic, partial cut away section of the hinge assembly according to a fourth preferred embodiment.

### DETAILED DESCRIPTION

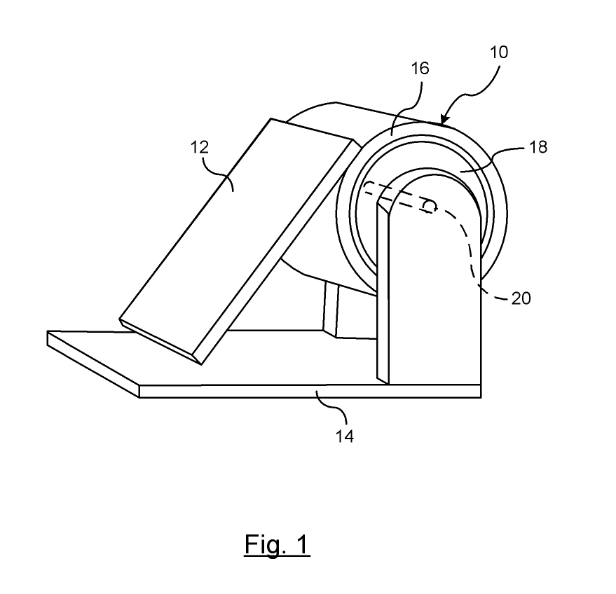

There is shown in FIG. 1 a hinge assembly 10 secured to a first attachment member 12 and a second attachment member 14. It should be understood that the first attachment member 12 or the second attachment member 14 may be integrally formed as part of the hinge assembly 10 or may be secured by other methods including, but not limited to, fasteners, welding, and crimping. In FIG. 1 as shown, the second attachment member 14 may be secured to a frame whereas the first attachment member 12 may be secured to a pivotable access panel. The first attachment member 12 and the second attachment member 14 form a structure that provides access to a compartment when pivoted to an open position and denies access to the compartment when pivoted to a closed position. The access panels include, but are not limited to, a vehicle door, a tailgate of pickup truck, a trunk, an engine hood, or an interior compartment door such as a glove box. It should also be understood that the attachment members may also be non-automotive applications.

The first attachment member 12 is attached and rotationally fixed to a first member 16 of the hinge assembly 10 that is radially spaced from a second member 18. The first member 16 and the second member 18 are concentric with a pin member 20. The pin member 20 constitutes a common axis between the first member 16 and the second member 18. The pin member 20 is secured and rotationally fixed to the second attachment member 14, which is fixed to a frame or similar structure. The second member 18 is fixed to the pin member 20, which prevents rotational movement of the second member 18 relative to the second attachment member 14. In this configuration, only the first member 16 and the first attachment member 12 rotate to pivot relative to the second attachment member 14 for allowing access to the compartment.

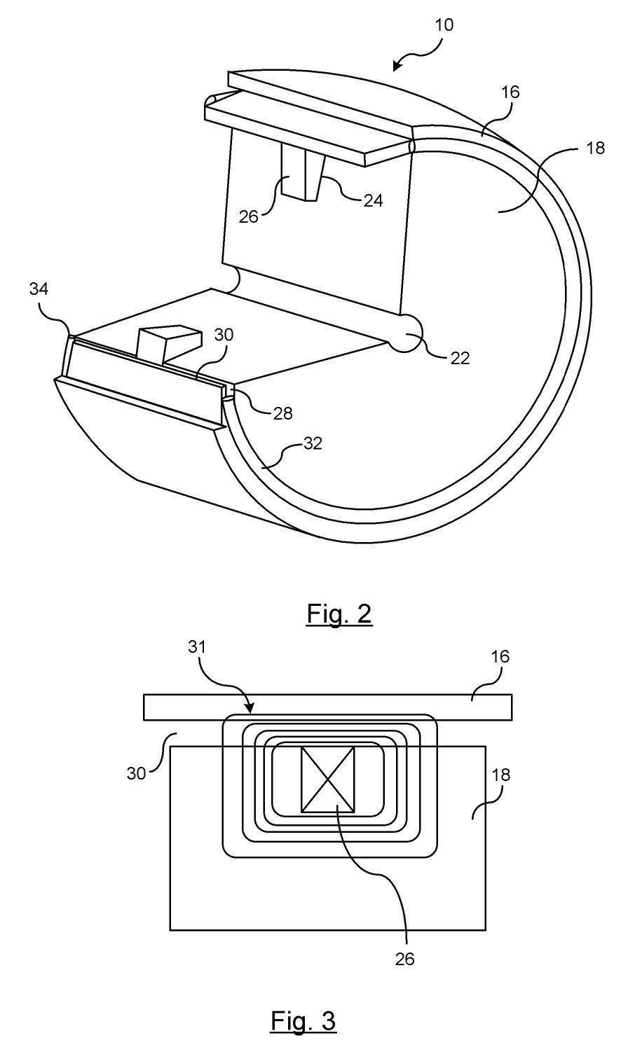

FIG. 2 illustrates the cut away section of the hinge assembly 10. The second member 18 is an inner core cylindrical-shaped member disposed radially interior of the first member 16. The second member 18 includes a bore 22 for receiving the pin member 20 (shown in FIG. 1) therethrough. The bore 22 serves as a common axis to both the first member 16 and the second member 18. The second member 18 further includes a grooved section 24. The grooved section 24 is preferably formed annularly around the outer circumferential surface of the second member 18. The grooved section 24 retains a magnetic field generating member 26 such as a permanent magnet or an electromagnet. The function of the magnetic field generating member 26 will be discussed in detail later.

The first member 16 is disposed radially from the second member 18. An annular cavity 28 separates the first member 16 and the second member 18. The annular cavity is filled with a magnetorheological (MR) fluid 30 thereby maintaining a spacing between the first member 16 and the second member 18. Seals 32 and 34 are provided on the open ends of the annular cavity 28 for maintaining the MR fluid 30 within the annular cavity 28.

The MR fluid 30 is a mixture of solid magnetizable particles in a liquid medium, such as an oil, that when subjected to a magnetic field increases the viscoelastic properties of the fluid. The fluid can change from a fluid state to an elastic solid state. The yield stress or shear strength of the MR fluid 30 can be variably controlled by controlling the intensity of the magnetic field generated by the magnetic field generating member 26. Magnetic particles that are suspended in the oil are randomly dispersed throughout the fluid when a magnetic field is not present. When a magnetic field is applied by the magnetic field generating member 26, the magnetic particles align themselves and form chain-like structures in the direction of the magnetic flux. The stronger the magnetic filed the stronger the chain of particles. As a result, the various chains of particles formed therein between the first member 16 and the second member 18 resist the shearing of the fluid, thus resulting in an increase in the apparent viscosity of the fluid. As a result, the torque (i.e., shear strength) applied between the first member and the second member is controlled thereby controlling the ability to pivot the first member relative to the second member. Moreover, the pivoting member may be latched to a partial opened position as a limiting case, as opposed to a fully opened position.

As described earlier, the magnetic field generating member 26 may include a permanent magnet having a predetermined strength. Alternatively, the magnetic field generating member 26 may include an electromagnet that is electrically controlled for varying the strength of the magnetic field applied to the MR fluid. For example, the current passing through the electromagnetic coil may be increased to maintain the hinge at a respective position when the hinge pivots to an open position and may be decreased to return the hinge to a closed position, or vice versa. To avoid the load on the power supply, the load could be reduced by using permanent magnets for activation of the MR fluid within the hinge and an electromagnet only when deactivation is required. In addition, the current may be increased variably that causes the hinge to stop pivoting at a respective position without utilizing a mechanical stop. Alternatively, the combination of the permanent magnet and an electromagnet may be used as a fail-safe condition for a power failure condition. Maintaining the device in an open position using an electromagnet could be susceptible to the device closing when not intended or desired. To avoid this occurrence, the hinge is maintained in a desired open position utilizing the permanent magnet. Since a permanent magnet maintains a constant magnetic field, the hinge would stay in the desired open position until an opposing torque overcomes the resistance torque due to the permanent magnet. By passing a know current through the electromagnet, its magnetic field could be used to overcome the field due to the permanent magnet and thus pivot the hinge back to the closed position.

FIG. 3 illustrates the magnetic field generated by the magnetic field generating member 26. The single member generates a magnetic field 31 that disperses partially into the MR fluid 30. The strength of the field and the amount of the MR fluid 30 affected by the magnetic field determines the resistance torque between the first member 16 and the second member 18. It should be understood that the magnetic field flux lines shown herein and throughout other embodiments described herein are provided for general illustrative purposes only and the flux lines may be different than what is shown.

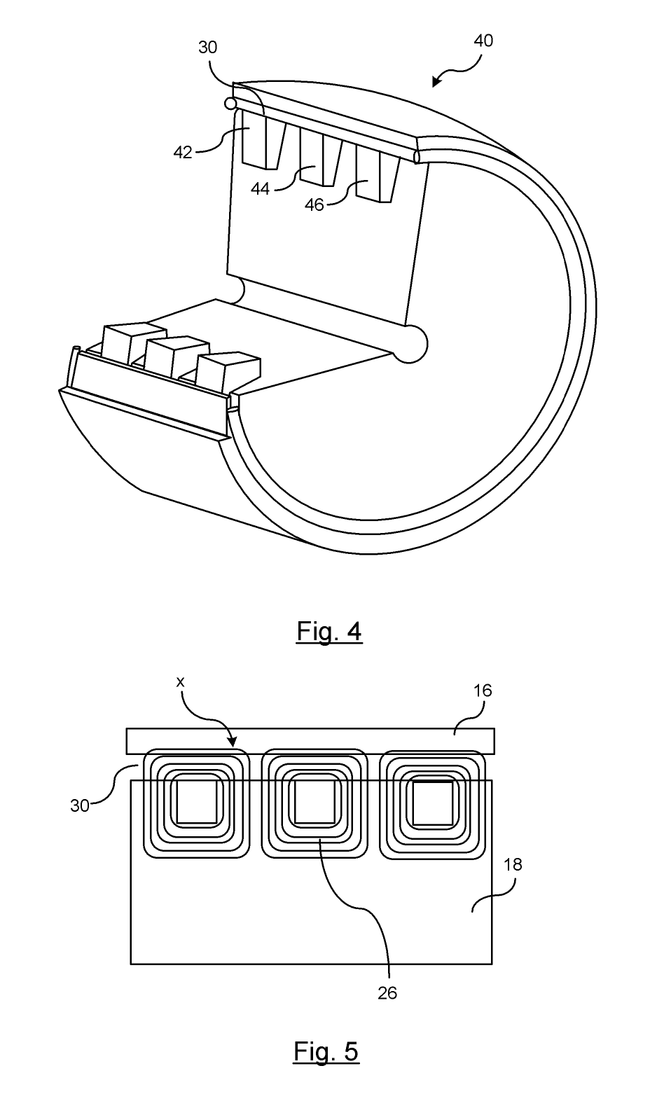

FIG. 4 illustrates a cut away section of a hinge assembly 40 according to a second preferred embodiment. The hinge assembly 40 includes a plurality of magnetic field generating members 42, 44, 46. The plurality of magnetic field generating members provide an electromagnetic field to generate flow resistance in the MR fluid 30 for generating the desired torque for the hinge assembly 40. It should also be understood that the plurality of magnetic field generating members 42, 44, 46 may be permanent magnets for applying a fixed magnetic field. Alternatively, the magnetic field generating members 42, 44, 46 may be electromagnetic members for generating an electromagnetic field as a result of an electrical charge applied to one or all of the magnetic field generating members 42, 44, 46. The strength of the magnetic field may be varied by either varying the electrical charge applied or by selectively energizing respective magnetic field generating members 42, 44, 46. Moreover, the plurality of magnetic field generating members 42, 44, 46 may be a combination of the permanent magnets and electromagnets. Electromagnets may be formed by a core center member having coils (e.g., radial windings) formed around the core center.

FIG. 5 illustrates the magnetic field generated by the magnetic field generating members 42, 44, 46. The plurality of magnetic field. The strength of the field and the amount of the MR fluid 30 affected by the each the magnetic fields generated by each of the magnetic field generating members 42, 44, 46 determines the resistance torque between the first member and the second member.

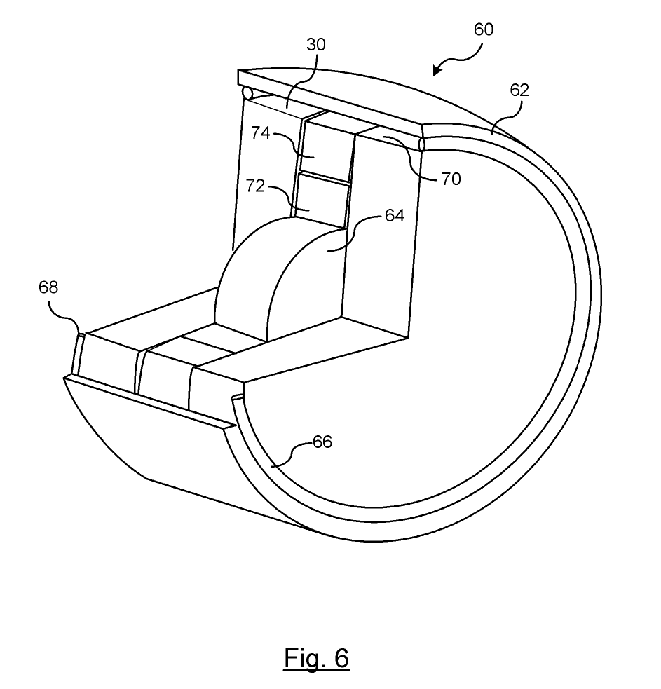

FIG. 6 illustrates a cut away section of a hinge assembly 60 according to a third preferred embodiment. The hinge assembly 60 includes a first member 62 (e.g., outer sleeve) and a second member 64. The second member 64 includes an inner core member and side disks that are affixed to the inner core. It should be understood that the inner core and the side disks may formed integral to one another. Seals 66 and 68 are provided on the open ends of an annular cavity 70 for maintaining MR fluid 30 within the annular cavity 70.

An electromagnet 72 is disposed radially outward from second member 64. The electromagnetic field of the electromagnet 72 is controlled by energizing the electromagnet with an electrical charge. A permanent magnet 74 is disposed radially outward from the electromagnet 72. As discussed earlier, the permanent magnet is utilized to increase the resistance of the MR fluid 30 within the annular cavity 70 when the hinge pivots to an open position. The electromagnet 72 is utilized to counter the effects of the permanent magnet 74 for decreasing the resistance of the MR fluid 30 when the hinge is required to pivot to a closed position. The combination of electromagnet 72 and the permanent magnet 74 is used as a fail-safe condition.

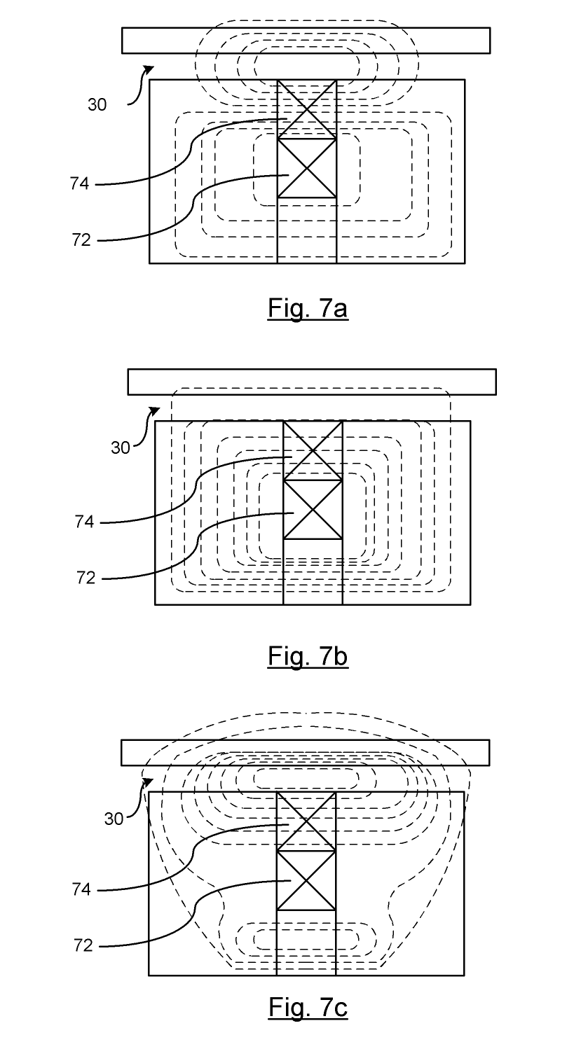

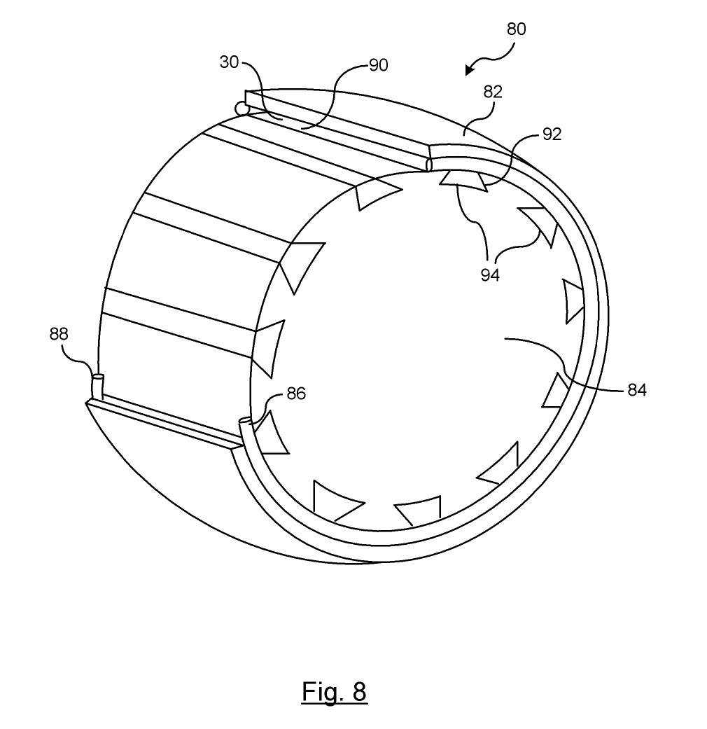

FIG. 7a-c illustrates a cross section view of the hinge assembly illustrating various magnetic fields generated by the electromagnet 72 and the permanent magnet 74. In FIG. 7a, no current is applied to the electromagnet 74. As a result, the magnet field acting on the MR fluid is applied solely by the permanent magnet 74.

In FIG. 7b, a current is applied to the electromagnet 72 to generate a magnetic flux that cancels out the magnetic field generated by the permanent magnet 74. As a result, no or a small magnetic field will be applied to the MR fluid 30. Canceling out of the magnetic fields may be used when low torsional resistance is required or when the hinge assembly is to be pivoted to a closed position. This allows the hinge assembly to be effortlessly pivoted to a respective closed position.

In FIG. 7c, a current is applied by the electromagnet 72 to generate a magnetic flux that cooperatively strengthens the magnetic field generated by the permanent magnet 74. The magnetic field cooperatively applied by the electromagnet 72 and the permanent magnet 74 increases the torque resistance of the MR fluid 30. The increased magnet field can be used when high torsional resistance is required to stop the hinge assembly at a desired pivoted location.

FIG. 8 illustrates a cut away section of a hinge assembly 80 according to a fourth preferred embodiment. The hinge assembly 80 includes a first member 82 (e.g., outer sleeve ring) and a second member 84 (e.g., inner pin core). Seals 86 and 88 are provided on the open ends of an annular cavity 90 for maintaining MR fluid 30 within the annular cavity 90.

The second member 84 may be formed from a laminated core having a plurality of winding slots 92. The plurality of winding slots extends axially along the laminated core. A plurality of axially wound coils 94 are formed in each of the winding slots. An electrical charge is applied to the plurality of the axially wound coils 94 for dynamically controlling the torque generated by the MR fluid 30 disposed within the annular cavity 90. As a result, the movement of the hinge assembly may be dynamically controlled by the magnetic field generated by the electromagnetic coils.

While certain embodiments of the present invention have been described in detail, those familiar with the art to which this invention relates will recognize various alternative designs and embodiments for practicing the invention as defined by the following claims.

What is claimed is:

1. A hinge for pivotably mounting a first attachment member to a second attachment member, the hinge comprising:
a first member attached to the first attachment member;
a second member pivotably engaging the first member and disposed within the first member, the second member configured for attachment to the second attachment member;
an annular cavity disposed between the first member and the second member, the annular cavity maintaining a spaced relationship between the first member and the second member;
a magnetorheological fluid disposed within the annular cavity; and
a magnetic field generating member configured to produce a change in a shear strength of the magnetorheological fluid within the annular cavity, the magnetorheological fluid applying a variable resistance torque between the first member and the second member for controlling a pivoting motion between the first member and the second member.

2. The hinge of claim 1 further comprising at least one seal for containing the magnetorheological fluid with the annular cavity.

3. The hinge of claim 1 wherein the magnetic field generating member is a permanent magnet.

4. The hinge of claim 1 wherein the magnetic field generating member is an electromagnet.

5. The hinge of claim 1 wherein the magnetic field generating member includes a permanent magnet and an electromagnet, wherein the permanent magnet generates the magnetic field acting on the magnetorheological fluid, and wherein the electromagnet generates a magnetic field that reduces the magnetic field generated by the permanent magnet for variably controlling the shear strength of the magnetorheological fluid.

6. The hinge of claim 1 wherein the magnetic field generating member includes a permanent magnet and an electromagnet, wherein the permanent magnet and the electromagnet cooperatively apply an enhanced magnetic field for increasing the shear strength of the magnetorheological fluid within the annular cavity.

7. The hinge of claim 6 wherein the enhanced magnetic field is controlled to decrease a speed of movement of the hinge assembly.

8. The hinge of claim 6 wherein the enhanced magnetic field is controlled to stop the hinge assembly at a respective pivoting location.

9. The hinge of claim 1 further comprising a groove within the second member, wherein the magnetic field generating member is secured within the groove.

10. The hinge of claim 9 wherein the second member is an annular core, and wherein the groove is annular formed in the outer surface of the second member.

11. The hinge of claim 1 wherein the first member is a sleeve and the second member is an inner core, wherein the magnetic field generating member is formed in the outer circumference of the inner core.

12. The hinge of claim 1 wherein the magnetic field generating member is a electromagnet, and wherein a power source is electrically coupled to the electromagnet for energizing the electromagnet.

13. The hinge of claim 1 wherein varying the power source varies the strength of the electromagnetic field, wherein varying the strength of the magnetic field varies the shear strength of the magnetorheological fluid for controlling a relative motion between the first member and the second member.

14. The hinge of claim 1 wherein the magnetic field generating member includes a plurality of magnetic field generation members formed annularly along an outer surface of the second member.

15. The hinge of claim 1 wherein the magnetic field generating member includes a plurality of magnetic field generation members formed axially along an outer surface of the second member.

16. The hinge of claim 1 wherein the second member is fixed with respect to the first member.

17. The hinge of claim 1 wherein the first member is formed integral to the first attachment member.

18. The hinge of claim 1 wherein the second member is formed integral to the second attachment member.
